(19) United States
(12) Patent Application Publication
(10) Pub. No.: US 2011/0039001 A1
(43) Pub. Date: Feb. 17, 2011

(54) METHOD FOR OBTAINING PLANT-BASED BEE FEED AND RESULTING PRODUCT

(75) Inventor: Alfonso Llovell Garcia, Alcantera De Xuquer (Valencia) (ES)

Correspondence Address: WENDEROTH, LIND & PONACK, L.L.P., 1030 15th Street, N.W.,, Suite 400 East, Washington, DC, 20005-1503, US

(73) Assignee: Mieles Llovell S.L.

(21) Appl. No.: 12/452,820

(22) PCT Filed: May 19, 2008
(86) PCT No.: PCT/ES2008/070096

§ 371 Date: Feb. 23, 2010

(30) Foreign Application Priority Data
Jul. 26, 2007 (ES) P200702085

(51) Int. Cl. A23K 1/18

(52) U.S. Cl. 426/541

(57) ABSTRACT

The invention relates to a method for obtaining plant-based bee feed and to the resulting product. The invention can be used to obtain a product with no production ceiling, which can be used to feed bees, providing all of the necessary nutrition contained in a honey and other naturally collected nutrients.

### OBJECT OF THE INVENTION

The object of the present invention patent is to present a new method for obtaining plant-based bee feed and the resulting product.

By means of this new method it is obtained a bee feed providing all the necessary vitamins so that the bees do not require any additional feed source, being able to solve by a single product all the nutritional needs of the same.

This new invention has special application in the apiculture field, where there is the need for making use of said product.

### BACKGROUND OF THE INVENTION

In view of the current high mortality that is taking place in most of the beehives, we have found that the lack of natural food made by the bees induces strong metabolic alterations and an extreme sanitary weakness in them.

Thus, it is vital for the future of apiculture and the development of the honey productive industry to make a substitute feed for honey.

Honey production and other apiculture derivatives have as main adverse effect the deprivation of the bee feed made by bees for themselves with the purpose of fulfilling their nutritional needs during the winter, or during adverse climatic factors.

Currently there are sugar-based bee feeds obtained by different means, which have not proved being able to be honey substitutes, nor the drug complementation has proved having high efficiency due to treating very specific problems, and existing even metabolic problems for removing the excess drug.

Pathogens virulently attacking the Apis mellifera already exist, and there are clear symptoms of high mortality among bees, commonly named “honey bee depopulation syndrome”. We have found that this symptomatology involves the nutritional lack of certain plant principles which are responsible for the Apis mellifera defense metabolism.

The present invention patent is directed to create a method for obtaining plant-based bee feed, as well as to the product itself, not presenting the mentioned drawbacks and allowing attaining a final product with better nutritional properties regarding the existing compositions utilizing sugar as base, and plant extracts which normally honey and other products made by the bee contain.

### DESCRIPTION OF THE INVENTION

This new method for obtaining plant-based bee feed and resulting product, object of the present invention patent, is presented in order to alleviate or, in its case, remove all the aforementioned problems.

This new method for making bee feed originates from a thorough honey making study from flower nectars, and the search for alternative sources in composition which makes it viable not to have a feed production ceiling, which can be used to feed bees, providing all the necessary nutrition contained in a honey and other nutrients naturally collected by the bee.

For that purpose, studies on many plant species have been conducted until finding those that have allowed obtaining the necessary extracts typical of the food base of the Apis mellifera and other Apis species.

The common carrier utilized for obtaining and preserving the necessary plant principles is sugar extracts, irrespective of the nature of the many sugars and polysaccharides existing in the plant world.

The plant varieties include the whole plant: leaves, stems, roots, flowers, fruits and seeds. So that when mentioning plant extract, it should be understood any part of the plant capable of being collected by man.

Plant extracts are obtained from plants subjected to milling, vaporization, and finally subjected to extraction processes in the specified conditions. In this way, a clean extract having the peculiarity of providing the bees (Apis sp) with the optimal nutritional conditions is attained, which in addition to providing kilocalories needed for their required daily exercise, provides the basic principles which activate their immune system

### DESCRIPTION OF THE DRAWINGS

In order to complement the description being carried out and with the object of helping to a better understanding of the characteristics of the invention, the present specification is accompanied by a figure, as an integral part thereof, wherein with illustrative but not limitative character, the following has been represented:

FIG. 1: Flowchart of the method for obtaining plant-based bee feed and resulting product.

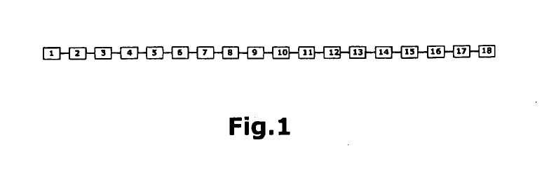

### PREFERRED EMBODIMENT OF THE INVENTION

Method for obtaining plant-based bee feed and resulting product, starting from a plant base (1) formed by any part of the vegetable or plant species (leaves, roots, or stems), as well as any type of fruits, flowers, seeds or derivatives thereof, that is rich in chemical constituent compounds of antioxidant nature derived from natural polyphenolic compounds, said plant base (1) will be used at a percentage between 0.01 and 60% of the total of the final product (18); subsequently said vegetable or plant species, as well as any type of fruits, flowers, seeds, or derivatives thereof, which are rich in chemical constituent compounds of antioxidant nature derived from natural polyphenolic compounds, forming the plant base (1) might be partially or completely dehydrated (2), according to the state wherein they are; then a milling (3) of said plant base (1) will be carried out, water (4) will be added to it in a range comprised between 5 and 50% thereof; subsequently it is mixed (5), for subsequently carrying out a vapor treatment (6) and removing undesirable volatile substances, according to the type of vegetable or plant species, as well as any type of fruit, seed, or derivatives thereof forming the plant base (1), limiting the maximum temperature of said vapor treatment (6) to 100 Celsius degrees; mono and/or polycarboxilic natural organic acids, as well as their salts (8) needed as to adopt a buffering effect of the pH between the value 2 and the value 9, are added to the resulting plant base (7). Enzymes of the type of amylases, glucoamylases, pectinases or pectinolytic enzymes, cellulases, and invertases (10) are added to the resulting mixture (9), in variable amount in the range from 1 mg/kg to 10000 mg/kg; the new obtained mixture (11) is homogenized and maintained at a temperature comprised between 25 and 55 Celsius degrees for a time not less than 30 minutes and not more than four hours; any type of sugar or polysaccharide (13) is added to this new mixture (12), in amounts oscillating between 5% and 900%; the new mixture (14) is homogenized and macerated by mixing (15) at a constant speed, obtaining a macerated mass (16), which is subjected to a solid/liquid separation (17), from which the final product (18) is obtained.

It should be highlighted that a plant base (1) formed by any part of the vegetable or plant species (leaves, roots, or stems), as well as any type of fruits, flowers, seeds or derivatives thereof, that is rich in chemical constituent compounds of antioxidant nature derived from natural polyphenolic compounds, said plant base (1) will be used at a percentage between 0.01 and 60% of the total of the final product (18).

It should also be highlighted that the plant base (1) may be formed by hydro-alcoholic plant extracts, with or without alcohol content, which when mixed with carbon hydrates, either sugars or polysaccharides, result in a product with characteristics similar to the final product (18).

Thus obtaining a final product (18) constituting a plant-based bee feed comprising:
Carbon hydrates, between 40 and 90% of the total of the final product (18).
Plant base content (1) formed by any part of the vegetable or plant species, as well as any type of fruit, flower, seed or derivative thereof, which is rich in chemical constituent compounds of antioxidant nature derived from natural polyphenolic compounds, at a percentage between 0.01 and 60% of the total of the final product (18).
Mono and/or polycarboxilic natural organic acids amounts, as well as their salts (8), necessary for adopting a buffering effect of the pH between the value 2 and the value 9.

Once the nature of the present invention has been sufficiently described, as well as a form for implementing it, it is only left to add that said invention can suffer certain variations in the method and in the composition, as long as said alterations do not substantially vary the characteristics claimed bellow.

1. Method for obtaining plant-based bee feed and the resulting product, characterized in that said method is composed by various well differentiated manufacturing steps. First, starting from a plant base (1) formed by any part of the vegetable or plant species (leaves, roots, or stems), as well as any type of fruits, flowers, seeds or derivatives thereof, which is rich in chemical constituent compounds of antioxidant nature derived from natural polyphenolic compounds, said plant base (1) will be used at a percentage between 0.01 and 60% of the total of the final product (18); subsequently said vegetable or plant species, as well as any type of fruits, flowers, seeds, or derivatives thereof, which is rich in chemical constituent compounds of antioxidant nature derived from natural polyphenolic compounds, forming the plant base (1) may be totally or partially dehydrated (2), according to the state wherein they are; then a milling (3) of said plant base (1) will be carried out, water (4) will be added to it in a range comprised between 5 and 50% thereof; subsequently is mixed (5) for subsequently carrying out a vapor treatment (6) and removing undesirable volatile substances, according to the type of vegetable or plant species, as well as any type of fruits, seed, or derivatives thereof forming the plant base (1), limiting the maximum temperature of said vapor treatment (6) to 100 Celsius degrees; mono and/or polycarboxilic natural organic acids, as well as their salts (8) needed as to adopt a buffering effect of the pH between the value 2 and the value 9, are added to the resulting plant base (7). Enzymes of the type of amylases, glucoamylases, pectinases or pectinolytic enzymes, cellulases, and invertases (10) are added to the resulting mixture (9), in variable amount in the range from 1 mg/kg to 10000 mg/kg; the new obtained mixture (11) is homogenized and maintained at a temperature comprised between 25 and 55 Celsius degrees during a time not less than 30 minutes and not more than four hours; any type of sugar or polysaccharide (13) is added to this new mixture (12), in amounts varying between 5% and 900%; the new mixture (14) is homogenized and macerated by mixing (15) which is carried out at a constant speed, obtaining a macerated mass (16) which is subjected to a solid/liquid separation (17), from which the final product (18) is obtained.

2. Method for obtaining plant-based bee feed and the resulting product according to claim 1, characterized in that it utilizes a plant base (1) formed by any part of the vegetable or plant species (leaves, roots, or stems), as well as any type of fruits, flowers, seeds or derivatives thereof, that is rich in chemical constituent compounds of antioxidant nature derived from natural polyphenolic compounds, said plant base (1) will be used at a percentage between 0.01 and 60% of the total of the final product (18).

3. Method for obtaining plant-based bee feed and the resulting product, characterized in that the plant base (1) might be formed by hydro-alcoholic plant extracts, with or without alcohol content, which when mixed with carbon hydrates, either sugars or polysaccharides, result in a product with characteristics similar to the final product (18).

4. Method for obtaining plant-based bee feed and the resulting product, characterized in that the final product (18), constituting a plant-based bee feed, comprises the following contents:
Carbon hydrates, between 40 and 90% of the total of the final product (18).
Plant base content (1) formed by any part of the vegetable or plant species, as well as any type of fruit, seed or derivative thereof, that is rich in chemical constituent compounds of antioxidant nature derived from natural polyphenolic compounds, at a percentage between 0.01 and 60% of the total of the final product (18).
Mono and/or polycarboxilic natural organic acids amounts, as well as their salts (8), needed as to adopt a buffering effect of the pH between the value 2 and the value 9.
